(19) United States
(12) Patent Application Publication
(10) Pub. No.: US 2019/0254314 A1
(43) Pub. Date: Aug. 22, 2019

(54) METHOD AND DEVICE FOR THE PRESERVATION OF LIQUIDS BY ULTRA HIGH PRESSURE HOMOGENIZATION

(71) Applicant: KRONES AG, Neutraubling (DE)

(72) Inventor: Roland FEILNER, Regensburg (DE)

(21) Appl. No.: 16/279,826

(22) Filed: Feb. 19, 2019

(30) Foreign Application Priority Data
Feb. 20, 2018 (DE) 10 2018 202 518.5

(51) Int. Cl. A23L 2/76; A23L 2/46; A23L 3/015; A23L 3/22; B01D 19/00

(52) U.S. Cl. CPC A23L 2/76; A23L 2/46; A23L 3/0155; A23V 2002/00; B01D 19/0005; B01D 19/0031; B01D 19/0036; A23L 3/22

(57) ABSTRACT

A device and a method for the preservation of liquids comprising: degassing of the liquid at a first temperature, and ultra high pressure homogenization of the liquid at a second temperature, wherein the second temperature is above the first temperature.

### CROSS REFERENCE TO RELATED APPLICATION

This present application claims priority to German Application No. 10 2018 202 518.5 titled “METHOD AND DEVICE FOR THE PRESERVATION OF LIQUIDS BY ULTRA HIGH PRESSURE HOMOGENIZATION,” filed on Feb. 20, 2018. The entire contents of the above listed application are hereby incorporated by reference in their entirety for all purposes.

### PRIOR ART

The invention relates to a method, a system, as well as a plant.

The preservation of products, in particular liquids, such as juices or milk, plays an important role in food and beverage plants.

For this purpose it is known to employ, inter alia, different sterilization methods in which the product is heated and sterilized when it reaches a predetermined sterilization temperature.

The product can there first be compressed, for example, by pressurization, in particular by mechanical pressurization, and thus heated to a predetermined sterilization temperature and then again be cooled due to a pressure decrease.

The ultra high-pressure homogenization (UHPH) described in EP 2 409 583 B1 can presently be mentioned as an example of such a high-pressure method for the sterilization of products.

The drawbacks of known plants and methods based on high-pressure processes for the preservation of liquids include possible impairment of product quality and a lack of energy efficiency.

### Object

It is therefore an object of the invention to improve a system and a method for the preservation of products, in particular liquids, especially e.g. in terms of product quality and energy efficiency.

### Solution

This is satisfied according to the invention by a method, a system, and a plant

An exemplary method for the preservation of liquids can comprise the following steps:

at least one degassing of the liquid at a first temperature, as well as

at least one ultra high pressure homogenization of the liquid at a second temperature, wherein the second temperature can be above the first temperature.

The liquids to be treated or preserved can be understood to be in particular e.g. liquid products such as beverages or liquid foods, such as juices or milk. Said liquids can also be understood to be, in particular, pumpable liquids.

A possible method described above can improve, among other things, the shelf life and the quality of liquid products.

For example, an oxidation effect impairing a quality, e.g. the flavor, and the shelf life of the product due to undesirable gases dissolved in the product, in particular, e.g. oxygen, can be reduced or prevented in that said undesirable gasses possibly dissolved in the product can be removed from the product by degassing. However, in the method presently described by way of example, the product composition can be left unchanged, for example, no additional substances, e.g. preservatives, are added to the product. In particular, for example, the product composition is not changed between the degassing of the product and the ultra high pressure homogenization of the product. Therefore, for example, no change occurs in the material composition of the liquid to be preserved during or between the degassing of the liquid at a first temperature and the ultra high pressure homogenization of the liquid at a second temperature.

In other words, the method presently described by way of example can be understood to be a purely one stream process with a single product stream unchanged in its material composition.

With the method presently described by way of example, the liquid can be brought to the first/a first predeterminable temperature by heating prior to the degassing.

Possible heating of the liquid to a first/said first temperature prior to degassing can facilitate the degassing process, since the permeation of undesired gases dissolved in the product can be increased and the undesired gases can then be more easily removed from the product.

Said exemplary first temperature can be in the range of 30° C. to 90° C., in particular e.g. in the range of 50° C. to 70° C.

The possible degassing of the liquid can inter alia be effected by way of pressure degassing and/or vacuum degassing and/or membrane degassing and/or by way of ultrasound.

When degassing the liquid, a stripping gas can optionally be employed, e.g. comprising inert gases such as nitrogen or noble gas, carbon dioxide or hydrogen or a combination of said gases.

Alternatively or additionally, vacuum degassing can be effected in a falling liquid film.

In the exemplary method for preservation, the liquid can prior to the ultra high pressure homogenization or after degassing, e.g. be brought to a second/said second temperature by further heating, where said second temperature can lie above the first temperature at which the degassing can be performed.

However, said exemplary heating to said second temperature can also be effected, for example, by the ultra high pressure homogenization itself

In other words, it is conceivable that the possible exemplary first temperature of the liquid, at which the degassing can be performed, can be a suitable initial temperature or starting temperature for the ultrahigh-pressure homogenization.

However, it is also conceivable that, alternatively or additionally, said exemplary heating to said second temperature can be effected by other direct or indirect ways of thermal treatment, for example by possible optional heat exchangers.

In other words, it is conceivable that the liquid can already have said exemplary second temperature, for example, at the beginning of the ultra high pressure homogenization. It is therefore possible that the exemplary possible first temperature of the liquid, at which the degassing can be performed, or said exemplary second temperature, can be, for example, an entry temperature of the liquid to be treated when it enters the ultra high pressure homogenization device.

However, a further increase in temperature can occur during ultra high pressure homogenization, for example, due to an increase in pressure and compression of the fluid, e.g. a further increase in temperature to a possible exemplary third temperature can occur.

This exemplary possible third temperature can be above said exemplary second temperature, and may therefore likewise be above said exemplary first temperature at which the degassing can be performed.

The value of said possible third temperature can depend, inter alia, on the pressure or the pressure ratio during the ultra high pressure homogenization and on the exemplary second temperature (the exemplary temperature at the beginning of the ultra high pressure homogenization, or the initial temperature or starting temperature of the liquid when entering the ultra high pressure homogenization device).

For example, the liquid treated by ultra high pressure homogenization can therefore have said exemplary second temperature or said third exemplary temperature as the exit temperature when exiting an exemplary ultra high pressure homogenization device, that is, at least at the end of the ultra high pressure homogenization process.

Furthermore, the ultra high pressure homogenization can be performed at a pressure between 200 and 600 MPa.

Said possible exemplary second temperature can depend, inter alia, on the type of product or the type of liquid to be treated, respectively, and for example at the beginning of the ultra high pressure homogenization be in a temperature range between 40° C. and 90° C.

The liquid can be cooled following the possible ultra high pressure homogenization.

The heat obtained by the cooling can be used to heat the liquid to said/the first temperature and/or to heat the liquid to said/the second temperature.

For example, product/product (P/P) regeneration can occur in which, for example, the hot, preserved or pasteurized product (the hot, preserved or pasteurized liquid) on a/the primary side of an exemplary system or system circuit can transfer heat, e.g. by way of heat exchangers, to a secondary side of a/the exemplary system or system circuit in which the product that is to be heated or is not yet preserved or not yet pasteurized (the liquid that is to be heated or is not yet preserved or not yet pasteurized) can flow.

Alternatively or additionally, product/water (P/W) regeneration can take place, in which, for example, separate heat exchangers can be used which can be coupled, for example, by way of a water circulation, for heating the product (the liquid that is to be heated, is not yet preserved or not yet pasteurized) or for cooling the product (the hot, preserved or pasteurized liquid), respectively.

Heat recovery can therefore take place and can improve the energy efficiency of the possible method for the preservation of liquids.

The/a liquid treated/preserved by way of ultra high pressure homogenization can then be hygienically or aseptically buffered or hygienically or aseptically stored and/or hygienically or aseptically filled into a container.

An exemplary system for the preservation of liquids can comprise the following components:

at least one degassing device, which can be configured to degas a liquid at a first temperature, and

at least one ultra high pressure homogenization device which can be configured to perform ultra high pressure homogenization of the liquid at a second temperature, where the second temperature can be above the first temperature.

Such a system can improve, in particular, the shelf life and the quality of liquid products as compared to known systems and plants, in particular for the reason that e.g. an oxidative potential affecting the shelf life and the quality of liquid products can be reduced in that, for example, undesired gasses dissolved in the product and having an oxidizing effect, e.g. oxygen, can be removed from the product. This can also contribute, inter alia, to an improved flavor of the product, because it can be prevented e.g. during ultra high pressure homogenization, that oxygen affects the flavor of the product.

Said exemplary system can further comprise at least one device, e.g. a heat exchanger, which can be configured to heat the liquid to the/a first temperature prior to the liquid being degassed.

For example, to a first temperature in the range previously specified, i.e. for example in the range of 30° C. to 90° C., in particular e.g. in the range of 50° C. to 70° C.

In addition, the exemplary system can further comprise at least one means/device, e.g. a further heat exchanger, which can be configured to heat the liquid to the/a second temperature after the liquid has been degassed. Said possible second temperature can be above said exemplary first temperature.

In addition, the exemplary system can further comprise at least one means/device, e.g. a further heat exchanger, which can be configured to cool the liquid treated or heated by ultra high pressure homogenization.

The system can there e.g. be configured to be able to use the heat obtained from cooling to heat the liquid to the first temperature and/or to heat the liquid to the second temperature.

The exemplary system can therefore enable heat recovery, which can improve the energy efficiency of the/a possible method for the preservation of liquids.

An exemplary system for the preservation of liquids described herein can be used inter alia in a filling plant, in particular a beverage filling plant for filling containers, in particular beverage containers such as barrels or bottles.

In other words, an exemplary filling plant can comprise, for example, at least one degassing device as described herein which can be configured to degas a liquid at a first temperature and at least one ultra high pressure homogenization device that can be configured to be able to perform ultra high pressure homogenization of the liquid at a second temperature, wherein the second temperature can be above the first temperature.

Also, said exemplary filling plant can be configured, inter alia, to be able to hygienically or aseptically buffer or hygienically or aseptically store a liquid treated or preserved by ultra high pressure homogenization.

### BRIEF DESCRIPTION OF THE DRAWINGS

The following figures illustrate by way of example:

FIG. 1: An exemplary system for the preservation of liquids

FIG. 2: Further exemplary system for the preservation of liquids

FIG. 3: An example method, according to at least one example of the present disclosure.

### DETAILED DESCRIPTION

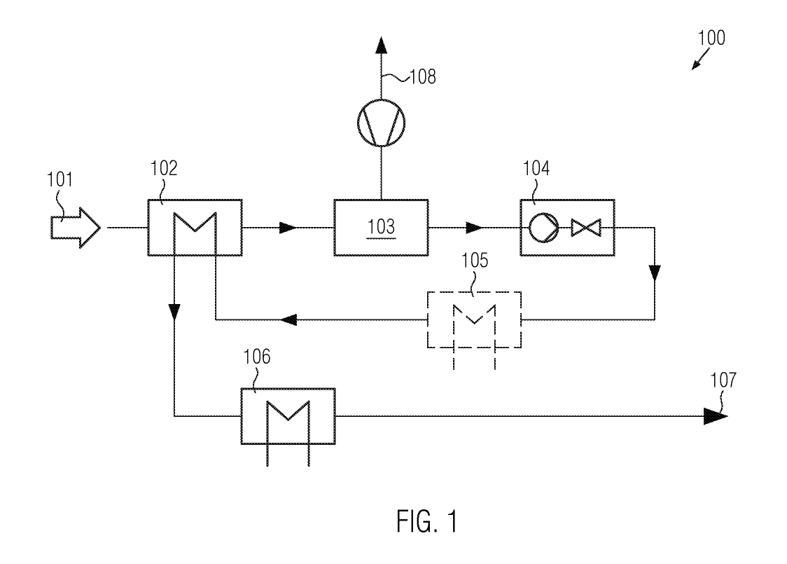

FIG. 1 by way of example illustrates a system 100 for the preservation of liquids.

For example, a liquid to be treated or a liquid to be preserved can there first be supplied to a first device 102 for thermally treating, e.g. heating the liquid, for example, a first heat exchanger 102.

Exemplary heat exchanger 102 can there heat the liquid to be treated to a first temperature. The liquid heated to said exemplary first temperature can subsequently be supplied to an exemplary degassing device 103 which can be configured to remove and discharge undesired gases 108 from the liquid to be treated.

Exemplary temperature ranges for said first temperature, at which degassing can be performed, can be e.g. in the range of 30° C. to 90° C., in particular e.g. in the range of 50° C. to 70° C.

Exemplary system 100 can further comprise an exemplary ultra high pressure homogenization device 104 that can be configured to sterilize or preserve the liquid to be treated at a second temperature which can be above said exemplary first temperature.

Said exemplary heating to said second temperature can there be achieved, for example, by the ultra high pressure homogenization itself and/or by other devices for thermal treatment, for example, by possible optional heat exchangers (not shown).

After ultra high pressure homogenization of the liquid by exemplary ultra high pressure homogenization device 104, the liquid heated by ultra high pressure homogenization can optionally be cooled, for example, by way of a possible further heat exchanger 105.

This optional cooling can be carried out, for example, when the temperature of the heated and preserved liquid is above a predetermined value, or above a predetermined temperature difference, e.g. a difference of more than 10 K between a/the primary side and a/the secondary side of the ultra high pressure homogenization, or e.g. at a difference of more than 10 K between the exit temperature and the entry temperature of the liquid in the ultra high pressure homogenization.

The possible heat, obtained by way of example by cooling the liquid heated by ultra high-pressure homogenization, for example, can in turn optionally be used to heat the untreated supplied liquid 101 that is to be treated to said exemplary first temperature. If, for example, the possible recoverable amount of heat after the ultra high pressure homogenization is not sufficient to heat the liquid to the first temperature, external heat energy can optionally in addition also be used.

If required, exemplary system 100 can additionally comprise a further device 106 for thermally treating the liquid treated by ultra high pressure homogenization, e.g. a further heat exchanger 106, in order to thermally treat the liquid to a desired temperature, e.g. to cool it, before the liquid exits system 100 and can be supplied, for example, to aseptic buffering and/or aseptic storage, and/or aseptic filling (not shown).

For the sake of completeness, it is to be mentioned that the exemplary arrows, which are not provided with separate reference numerals, represent a possible exemplary process direction or flow direction of the liquid in the system and can represent an exemplary open cycle of the untreated liquid 101 from feed to discharge exit 107, in which optionally e.g. a heat surplus generated by the ultra high pressure homogenization can be used for heating the liquid to be treated to said exemplary first temperature.

In the illustrated exemplary cycle of the fluid through system 100, a liquid to be treated can pass once through any possible station, such as degassing device 103, ultra high pressure homogenization device 104, and devices 102, 105, 106 (in a predetermined direction) before the (treated) liquid leaves system 100 again at exit 107.

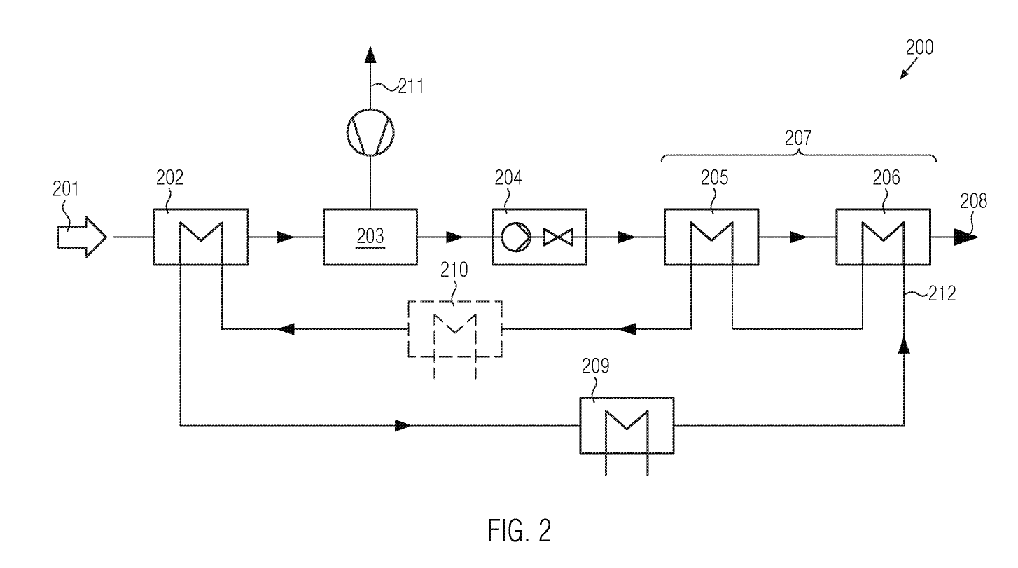

FIG. 2 by way of example illustrates a further system 200 for the preservation of liquids for illustrating aspects of the invention.

Similar to system 100, exemplary system 200 comprises an exemplary first device 202 for thermally treating, e.g. heating, the liquid to be treated 201 that is supplied via a feed, for example, a first heat exchanger 202.

Possible exemplary heat exchanger 202 can there heat the liquid to be treated to a first temperature. Subsequently, the liquid heated to said exemplary first temperature can be supplied to an exemplary degassing device 203 which can be configured to remove and discharge undesired gases 211 from the liquid to be treated.

Exemplary temperature ranges for said first temperature, at which degassing can be performed, can be e.g. in the range of 30° C. to 90° C., in particular e.g. in the range of 50° C. to 70° C.

Exemplary system 200 can further comprise an exemplary ultra high pressure homogenization device 204 that can be configured to sterilize or preserve the liquid to be treated at a second temperature that can be above said exemplary first temperature.

Exemplary system 200 can further comprise an exemplary further device 207 for thermally treating, e.g. for cooling, the liquid. Said exemplary device 207 can be e.g. configured as a heat exchanger or as a heat exchanger block which can comprise e.g. a plurality of heat exchangers, such as heat exchangers 205, 206.

Said device 207 or said exemplary heat exchangers 205, 206 can be configured to thermally treat the liquid treated by ultra high pressure homogenization to a desired temperature, in particular, for example, to cool it.

System 200 can be configured such that the heat recovered from cooling the liquid heated by the ultra high pressure homogenization can be utilized to, for example, (as shown) heat the supplied liquid to be treated 201 to the exemplary first temperature and/or to heat the degassed liquid to a second exemplary temperature (not shown) for ultra high pressure homogenization after an exemplary degassing by degassing device 203.

In contrast to system 100, heat recovery of the heat energy of the liquid heated by the ultra high pressure homogenization can take place in system 200 shown by way of example by way of a separate water circulation 212.

For this purpose, further devices 209, 210, e.g. additional heat exchangers, can be employed.

The treated and preserved liquid can exit 208 system 200 and be supplied, for example, to an aseptic buffer and/or an aseptic storage and/or aseptic filling (not shown).

Similar to the example of FIG. 1, the exemplary arrows in FIG. 2, which are not provided with separate reference numerals, also identify possible exemplary process directions or flow directions of the liquid in the system.

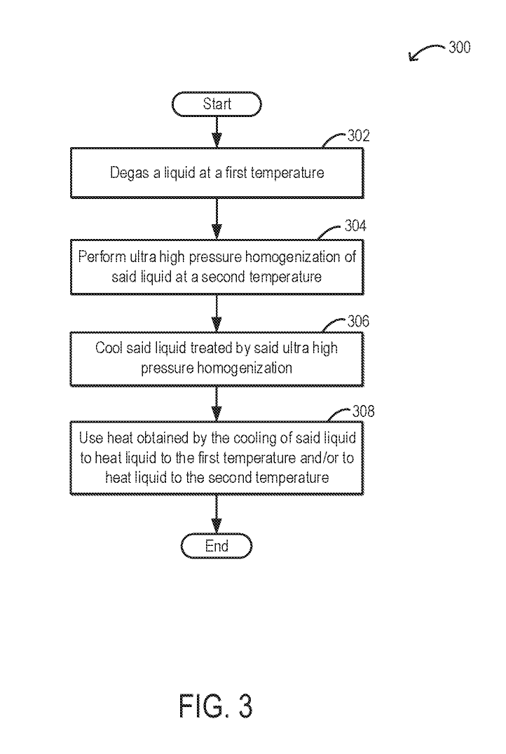

Turning now to FIG. 3, a flow chart of an example method 300 according to at least embodiment of the present disclosure is shown.

Method 300 may be a method for the preservation of liquids, and may begin at step 302 where a liquid is degassed at a first temperature. In at least one example, said liquid may be brought to the first temperature by heating said liquid prior to said degassing. The first temperature may be in a range of 30° C. to 90° C. For example, the first temperature may be 50° C. to 70° C.

Further, in at least one example, the degassing of said liquid may be effected by way of pressure degassing and/or vacuum degassing and/or membrane degassing. In at least one example, a stripping gas may be used during the degassing of said liquid and/or vacuum degassing may occur in a falling liquid film. In examples where a stripping gas may be used, the stripping gas may be nitrogen

Following step 302, method 300 may include performing ultra high pressure homogenization of said liquid at a second temperature at step 304. In one or more examples, the second temperature may lie above the first temperature. Said liquid may be brought to the second temperature by heating prior to said ultra high pressure homogenization, for example. Additionally, in at least one example, said liquid treated by the ultra high pressure homogenization may be hygienically or aseptically buffered and/or may be hygienically or aseptically filled. The ultra high pressure homogenization may be performed at a pressure between 200 and 600 MPa, in at least one example. After performing ultra high pressure homogenization of said liquid at the second temperature in step 304, method 300 may further comprise cooling said liquid that was treated by said ultra high pressure homogenization at step 306. Furthermore, after cooling said liquid treated by said ultra high pressure homogenization at step 306, method 300 may further comprise using heat obtained by the cooling at step 306 to heat said liquid to the first temperature and/or to heat said liquid to the second temperature.

The reference numerals are there allocated as follows:
100 Exemplary system for the preservation of liquids
101 Exemplary supply of (untreated) liquid/liquid to be treated
102 Exemplary (first) device for thermally treating, e.g. heating the liquid, exemplary (first) heat exchanger
103 Exemplary degassing device
104 Exemplary ultra high pressure homogenization device
105 Exemplary (second) device for thermally treating, e.g. cooling the liquid, exemplary (second) heat exchanger
106 Exemplary (third) device for thermally treating, e.g. cooling the liquid, exemplary (third) heat exchanger exemplary (second) heat exchanger
107 exemplary exit/exemplary discharge of treated/preserved liquid
108 Exemplary escaping gas/gas removed from the liquid
200 Exemplary alternative system for the preservation of liquids
201 Exemplary supply of liquid/liquid to be treated
202 Exemplary (first) device for thermally treating, e.g. heating the liquid, exemplary (first) heat exchanger
203 Exemplary degassing device
204 Exemplary ultra high pressure homogenization device
205 Exemplary (second) device for thermally treating, e.g. cooling the liquid, exemplary (second) heat exchanger
206 Exemplary (third) device for thermally treating, e.g. cooling the liquid, exemplary (third) heat exchanger
207 Exemplary device for thermally treating, e.g. cooling the liquid, exemplary heat exchanger block comprising heat exchangers 205, 206
208 Exemplary exit/exemplary discharge of treated/preserved liquid
209 Exemplary (fourth) device for thermally treating, e.g. cooling the liquid, exemplary (fourth) heat exchanger
210 Exemplary (fifth) device for thermally treating, e.g. cooling the liquid, exemplary (fifth) heat exchanger
211 Exemplary escaping gas/gas removed from the liquid
212 Exemplary water circulation for exemplary heat recovery

1. A method for the preservation of liquids comprising:
degassing a liquid at a first temperature; and
performing ultra high pressure homogenization of said liquid at a second temperature, wherein the second temperature lies above the first temperature.

2. The method according to claim 1, wherein said liquid is brought to the first temperature by heating said liquid prior to said degassing.

3. The method according to claim 1, wherein said liquid is brought to the second temperature by heating prior to said ultra high pressure homogenization.

4. The method according to claim 1, where said liquid treated by said ultra high pressure homogenization is cooled.

5. The method according to claim 1, wherein said liquid treated by said ultra high pressure homogenization is cooled and the heat obtained by the cooling is used to heat said liquid to the first temperature and/or to heat said liquid to the second temperature.

6. The method according to claim 1, wherein the degassing of said liquid is effected by way of pressure degassing and/or vacuum degassing and/or membrane degassing.

7. The method according to claim 6, wherein a stripping gas is used during the degassing of said liquid and/or vacuum degassing occurs in a falling liquid film.

8. The method according to claim 7, wherein the stripping gas is nitrogen.

9. The method according to claim 1, wherein said liquid treated by ultra high pressure homogenization is hygienically or aseptically buffered and/or hygienically or aseptically filled.

10. The method according to claim 1, wherein said ultra high pressure homogenization is performed at a pressure between 200 and 600 MPa.

11. The method according to claim 1, wherein the first temperature is in a range of 30° C. to 90° C.

12. The method according to claim 11, wherein the first temperature is 50° C. to 70° C.

13. The method according to claim 1, wherein no change occurs in a material composition of said liquid during or between said degassing of said liquid at the first temperature and said ultra high pressure homogenization of said liquid at the second temperature.

14. A system for the preservation of liquids comprising:
at least one degassing device which is configured to degas a liquid at a first temperature; and
at least one ultra high pressure homogenization device which is configured to perform ultra high pressure homogenization of said liquid at a second temperature, wherein said second temperature is above said first temperature.

15. The system according to claim 14, further comprising at least one device that is configured to heat said liquid to the first temperature prior to the degassing of the liquid, and/or that is configured to heat said liquid to the second temperature after the degassing of the liquid.

16. The system according to claim 15, wherein the at least one device is a heat exchanger.

17. The system according to claim 14, further comprising at least one device that is configured to cool the liquid treated by ultra high pressure homogenization.

18. The system according to claim 17, wherein the at least one device is a heat exchanger.

19. The system according to claim 18, where said system is configured to use the heat obtained from cooling to heat the liquid to the first temperature and/or to heat the liquid to the second temperature.

20. A filling plant that is a beverage filling plant for filling containers, comprising:
a system for a preservation of liquids, the system comprising:
at least one degassing device which is configured to degas a liquid at a first temperature; and
at least one ultra high pressure homogenization device which is configured to perform ultra high pressure homogenization of said liquid at a second temperature, wherein said second temperature is above said first temperature.
